(19) United States
(12) Patent Application Publication
(10) Pub. No.: US 2007/0075101 A1
(43) Pub. Date: Apr. 5, 2007

(54) Fluid container and dispensing valve therefor

(75) Inventors: Kevin Von Essen, San Jose, CA (US); Jennifer Davis-Wilson, Redwood City, CA (US); Joseph Hei, Palo Alto, CA (US); Chris Flink, Palo Alto, CA (US); Bryan White, Fremont, CA (US)

Correspondence Address: PEPSICO, INC.;c/o GOODWIN PROCTER LLP, 599 LEXINGTON AVE, NEW YORK, NY, 10022, US

(73) Assignee: PepsiCo, Inc., Purchase, NY (US)

(21) Appl. No.: 11/242,092

(22) Filed: Oct. 3, 2005

(51) Int. Cl. B67D 5/06

(52) U.S. Cl. 222/505; 222/509

(57) ABSTRACT

A dispensing system includes a container and a dispensing valve for dispensing fluid from the container. The container can be utilized in one of various positions and the dispensing valve includes plural spouts to accommodate the selected orientation of the container. The valve is designed to maintain the exit flow rate within a predetermined range regardless of the fluid pressure head within the container.

### BACKGROUND OF THE INVENTION

1. Field of the Invention

The present invention relates to a fluid container and a dispensing valve therefor. The container can be positioned in any of various orientations, with the dispensing valve being operable in any selected container orientation. The dispensing valve can dispense the fluid at a substantially constant rate or within a predetermined range, regardless of the orientation of the container and the amount of fluid in the container.

1. Description of the Related Art

Fluid containers and valves for dispensing fluid are well-known. Such containers and valves can be used, for example, in a system for dispensing beverages or other liquids used by consumers in their homes. Among the considerations of such containers and dispensing valves are low costs, trouble-free and reliable valve action and being disposable or recyclable.

However, such containers and valves have limited uses. For example, in order to reliably dispense all of the fluid in the container, the dispensing valve is typically placed on the lower end of a front face of the container, with the spout of the dispensing valve directed downwardly. This limits the operable positions of the container, such that it can only rest on its bottom face when actuated. If the container were to be stored in a refrigerator to keep the fluid cool, this would limit the ways in which the available space within the refrigerator can be used. In addition, the flow rate through the dispensing valve is typically dependent upon the amount of fluid or head pressure in the container. When the container is full the flow rate is greatest and the flow rate gradually decreases as the remaining volume of fluid is depleted. This can result in a flow rate that is too great to control the discharging fluid into a smaller vessel, such as a glass, when the container is full, and that is too slow when there is less fluid in the container. In addition, many dispensing systems need to be punctured, or otherwise vented, in order to establish a desired and consistent flow rate. If not, in order to equalize the pressure in the head space in an unvented container as the fluid level drops during dispensing, air will be sucked through the nozzle and valve, interrupting fluid discharge.

### SUMMARY OF THE INVENTION

The present invention can provide a fluid container and dispensing valve which avoid the disadvantages of prior containers and valves.

The present invention can also reliably control the flow rate through the dispensing valve throughout dispensing of the entire fluid contents of the container.

The present invention can further provide a container that can be positioned in one of various orientations to allow optimum use of available space.

In addition, the present invention can allow smooth fluid discharge without puncturing the container.

According to one aspect, the present invention relates to a dispensing valve for dispensing fluid from an outlet of a fluid source. The valve includes a fluid passage, a valve seat disposed in the fluid passage, a valve member for engaging with and moving relative to the valve seat, the valve member closing the fluid passage when fully engaged with the valve seat and varying a fluid passage between the valve member and the valve seat in correspondence with movement relative to the valve seat, an actuator for moving the valve member-and a spring disposed between the valve member and the actuator. The spring controls a magnitude of the movement of the valve member relative to the valve seat due to movement of the actuator, the magnitude being dependent upon pressure of the fluid source.

According to another aspect, the present invention relates to a dispensing valve for dispensing fluid from an outlet of a fluid source. The valve includes a fluid passage and means for dispensing the fluid from the outlet of the fluid source through the fluid passage within a predetermined flow rate range independently of pressure of the fluid source.

According to yet another aspect, the present invention relates to a fluid dispensing system including a container having a container outlet for dispensing a fluid and a dispensing unit. The dispensing unit has a valve and plural dispensing outlets at different dispensing positions. Each of the dispensing outlets is in communication with the container outlet when the valve is open. The fluid flow rate through the valve is controlled so the fluid will exit through only one of the valve outlets when dispensing.

Other objects, features and advantages of the present invention will become more apparent from the following detailed description of the preferred embodiments when taken together with the accompanying drawings in which:

### BRIEF DESCRIPTION OF THE DRAWINGS

FIG. 1 is a perspective view of the fluid container and dispensing valve according to the present invention.

FIG. 2 is a front elevational view of a portion of the container and dispensing valve shown in FIG. 1.

FIG. 3 is a cross-sectional view of the dispensing valve of a first embodiment in a closed position.

FIG. 4 is a cross-sectional view of the dispensing valve of FIG. 3 in a partially open position.

FIG. 5 is a cross-sectional view of the dispensing valve in a fully open position.

FIG. 6 is a cross-sectional view of a modified dispensing valve of the present invention.

### DETAILED DESCRIPTION OF THE PREFERRED EMBODIMENTS

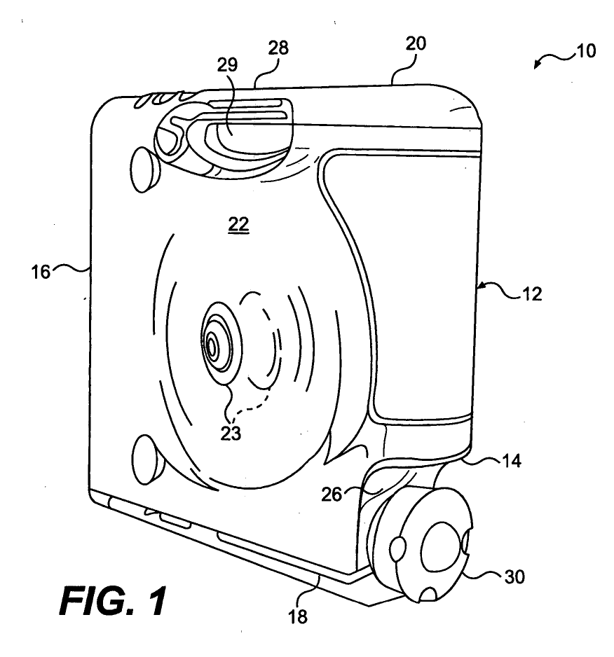

Referring to FIG. 1, the dispensing system 10 of the present invention will be described. Dispensing system 10 includes a container 12 and a dispensing valve assembly 30. Although the shape of container 12 is not limited, in a preferred form the container is of a “suitcase” design. More specifically, container 12 is of dimensions proportional to a suitcase in that it has a narrow width dimension and relatively longer length and height dimensions. Container 12 includes six faces: front face 14, rear face 16, bottom face 18, top face 20, left side face 22 and right side face 24. Front and rear faces 14, 16, which are defined by the width and height dimensions, are relatively narrow but tall. Bottom and top faces 18, 20 which are defined by the width and length dimensions are relatively slim but long. Left side and right side faces 22, 24, which are defined by the length and height dimensions, are both relatively long and wide. The specific dimensions of container 12 are not limited, but it is preferred that the container be sized so as to fit within a conventional residential refrigerator. For example, the length, height and width of container 12 can be 30.5 cm×40.7 cm×10.2 cm (12″×16×4″). Left side and right side faces 22, 24 because they are relatively broad, can include structural ribbing 23 to prevent excessive deformation due to internal or external forces.

At the lower end of front face 14 of container 12, an opening 27 is formed to which valve assembly 30 can be secured. In order to minimize the footprint of container 12, a recess 26 can be formed at the lower end of front face 14 and the front, lower corners of left side and right side faces 22, 24 to accommodate valve assembly 30. Recess 26 should be sized to accommodate the projecting dimension of valve assembly 30 such that the valve assembly will not protrude beyond front face 14.

Container 12 can also include a handle 28 for ease of carrying. Handle 28 can be molded integrally with the container or can be attached in a separate manufacturing step. In the preferred embodiment, handle 28 is formed integrally with the container and includes a narrow section of top face 20 and a recess or void 29 to accommodate a consumer's fingers.

As designed, container 12 has plural dispensing positions. As shown in FIG. 1, one dispensing position is the upright position in which the dispenser rests on bottom face 18. However, the dispenser can also rest on right side face 24 with nozzle assembly 30 disposed at its left end, or on left side face 22 with the nozzle assembly disposed at its right end. With these positioning options, container 12 can be optimally positioned depending on the available space. For example, if container 12 is to be stored in a refrigerator and only a narrow but tall space is available, it can be stored in the upright position with valve assembly 30 facing forward and being readily accessible. If only shallow shelf space is available, the container can be oriented on either its right side or left side face 22, 24, with the valve assembly being positioned closest to the door opening for easy access. Valve assembly 30 is designed to accommodate any of the container orientations, as will now be described.

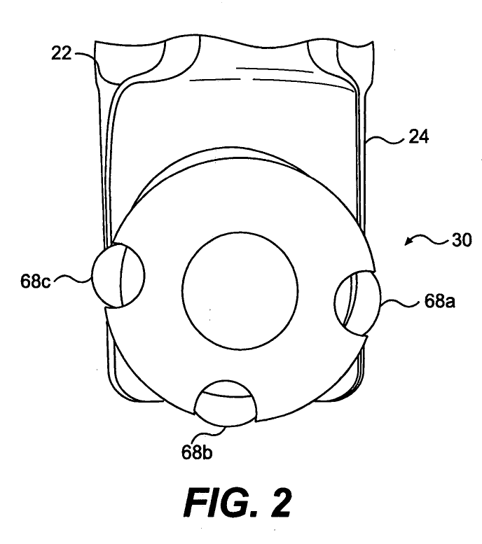

Referring to FIGS. 2-5, valve assembly 30 includes a valve body 32 for engaging with opening 27 in recess 26 of container 12. The opening and valve housing are preferably of a circular shape and can be connected by any known means so long as they are coupled in a fluid-tight manner. For example, valve body 32 can include a flange 34 that can be threaded, glued or welded to opening 27. Valve body 32 includes a valve seat 36 and two or more valve flow passage rings (steps or shoulders) 38, 40. Valve seat 36 and valve passage rings 38, 40 can be integrally formed with valve body 32. Valve passage rings 38, 40 define different peripheries of the valve body and can be in the form of concentric steps.

Valve assembly 30 further includes a valve member or poppet 42 having a peripheral shoulder 43 for engaging with valve seat 36 and cooperating with valve passage rings 38, 40 to variably restrict fluid flow. Poppet 42 preferably is of a circular shape and includes a valve stem 44. Valve stem 44 is secured at its proximal end to the center of poppet 42 and is preferably formed integrally therewith. Movement of valve stem 44 in its axial direction causes equivalent movement of poppet 42 toward or away from valve seat 36. At a distal end of valve stem 44, an engagement flange 46 is provided. When poppet 42 is moved to be adjacent first valve passage ring 38, an annular passage is defined between the peripheral shoulder 43 of poppet 42 and the inner wall of ring 38. The cross sectional area of this passage is relatively small. When poppet 42 is displaced further to be adjacent second ring 40, the formed annular passage is of a greater area.

Valve stem 44 is driven by an actuator assembly 48. Actuator assembly 48 includes an actuator button 50 and an actuator shaft 52. The actuator shaft includes a shoulder 54 for engaging an exterior or distal side of valve engagement flange 46 of valve stem 44. Actuator shaft 52 further includes detents 56 for engaging an interior or proximal side of valve engagement flange 46. The engagement of detents 56 with engagement flange 46 establishes the limit of leftward movement of actuator button 50 due to the bias of spring 60. This retains the actuator button within the valve assembly. An actuator web 58 can be used to seal fluid from leaking through actuator assembly 48. An actuator spring 60 is disposed between valve stem 44 and actuator button 50. In particular, spring 60 is disposed between valve stem 44 and actuator button 50. In particular, spring 60 is constrained by engagement flange 46 of valve stem 44 and an interior side of actuator button 50. Spring 60 is also confined within actuator shaft 52.

A cap 62 covers valve body 32. Cap 62 can be formed integrally with the valve body or can be formed separately therefrom so long as fluid cannot leak past any junction between cap 62 and valve body 32. Cap 62 includes an actuator passage 64 defined by a central opening. Passage 64 is sized large enough to allow actuator shaft 52 to reciprocatingly slide freely therethrough, yet small enough to guide actuator shaft 52 without allowing much play in directions transverse to the axial direction. Cap 62 further includes a common chamber 66 bounded by valve body 32, poppet 42 and the underside of cap 62, and one or more spout openings 68a, 68b, 68c communicating with chamber 66. Although only one spout opening is necessary, plural spout openings are preferred to enable container 12 to be operable in various positions. In a preferred embodiment, spout openings 68a-68c are disposed at 3 o'clock, 6 o'clock and 9 o'clock positions to accommodate the three orientations of the container described above.

Cap 62 can include an ergonomic gripping lip 70 to be grasped by the consumer's fingers to enable one-handed actuation. Cap 62 can further include a recess for engaging a bead of actuator web 58 to retain the button on the cap and prevent any leakage therethrough.

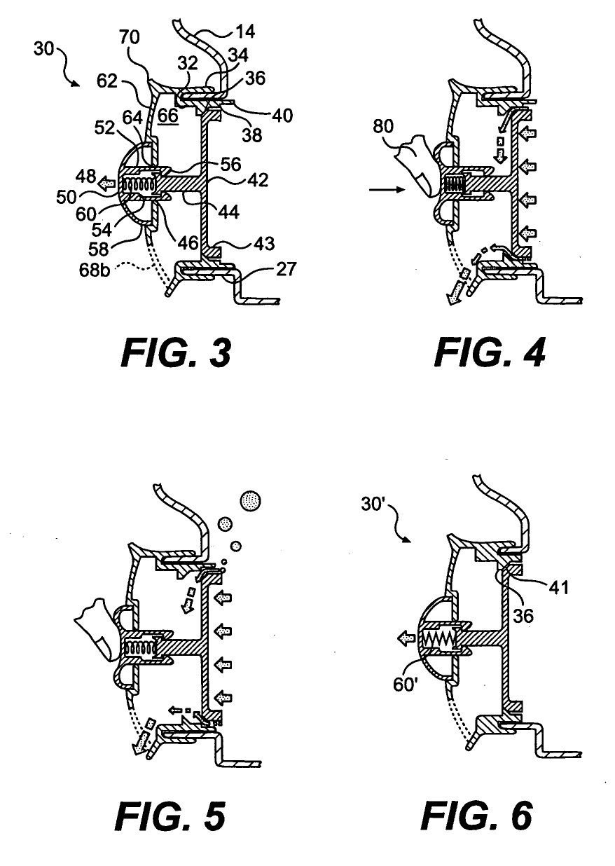

The actuation of the valve assembly 30 will now be described. When container 12 is in the upright position shown in FIG. 1 and full of fluid, the fluid pressure head will force valve poppet 42 against valve seat 36 to keep the valve assembly closed as shown in FIG. 3. When a consumer wishes to dispense fluid from the container, the consumer presses his or her finger 80 against actuator button 50 to urge actuator shaft 52 inwardly in the rightward direction as shown in FIG. 4. Because the pressure head within the container is relatively high, the force of the consumer's finger acting via spring 60 is insufficient to move poppet 42 off valve seat 36, so the spring compresses. Spring 60 continues to be compressed until shoulder 54 of actuator shaft 52 engages flange 46 of valve stem 44. Then there is a direct connection between actuator button 50 and valve stem 44 and the pressing force is sufficient to move poppet 42 off valve seat 36 to define a small flow passage between first flow ring 38 and the periphery of poppet 42. Actuator assembly 48 is dimensioned such that a user cannot force poppet 42 beyond first flow ring 38 when shoulder 54 of actuator shaft 52 directly engages flange 46 of valve stem 44.

The dimensions of the annular flow passage when poppet 42 cooperates with the first flow ring are such that fluid within a first predefined, high range of head pressure (above a predetermined threshold pressure) will flow past the valve at a predetermined flow rate or within a predetermined narrow range. This flow rate or range is sufficiently low that the fluid will flow through chamber 66 and out the lowermost spout opening (i.e., lowermost with respect to the gravitational direction) without exiting through the other two spout openings. More particularly, the flow rate is designed such that flow rate out of chamber 66 is not less than the flow rate into the chamber such that the chamber will not fill up with fluid and overflow out the unused spout openings. Further, the flow rate past the valve is sufficiently low that fluid will not jet or splash out of the other two spout openings.

As the fluid is dispensed through the valve, the air pressure in the head space of the container decreases to be negative. In order to equalize the pressure without puncturing or otherwise venting the container, air supplied to chamber 66 through the unused spouts 68 can enter the container past poppet 42. Thus, fluid discharge through the lowermost spout will not be interrupted and will flow smoothly.

When it is desired to cease dispensing, the user lifts his or her finger off actuator button 50 and poppet 42 is forced by the fluid pressure within the container to re-engage with valve seat 36. Spring 60 expands to urge actuator button 50 to its non-actuated position as shown in FIG. 3.

So long as the fluid pressure head within container 12 is within the first, higher predefined range, fluid will be dispensed using the restricted flow passage as shown in FIG. 4, regardless of whether the actuator assembly is continuously pressed or intermittently pressed. Once the pressure head within container 12 drops to or below the predetermined threshold pressure such that it is within a predefined second, lower pressure range, a wider flow passage will be established. As shown in FIG. 5, when a user presses actuator button 50 in this lower pressure state, the pressure acting on the container side of poppet 42 is decreased and actuator button 50 can move valve stem 44 via spring 60 without direct contact between actuator shaft 52 and valve stem 44. This enables the stroke of the valve shaft to increase and move poppet 42 to be adjacent to and cooperate with second flow ring 40 to establish a wider valve passage as shown in FIG. 5. If the fluid pressure head drops below the threshold during dispensing while button 50 is depressed, spring 60 will urge poppet 42 to be adjacent second flow ring 40 without interrupting dispensing. However, because the pressure within the container is lower, the fluid flow rate through the valve is not as great as it would be under a higher pressure and, in fact, approximates the flow rate under the higher pressure conditions shown in FIG. 4 or is at least within the same narrow range. As discussed above, this flow rate or range is sufficiently low so that the fluid will only be discharged through the lowermost spout opening, in this case spout opening 68b.

As is evident from the foregoing description, the spring rate or spring constant of spring 60 is designed such that, in response to a given actuation force, the spring can move poppet 42 off the valve seat in the rightward direction against the force due to the fluid pressure in the leftward direction if the force due to the pressure is below the threshold value. Therefore, the spring rate is designed taking various parameters into consideration including the surface area of the poppet 42, the expected pressure head throughout the entire dispensing volume of the container and the desired flow rate range.

With the above arrangement, fluid can be discharged through valve assembly 30 at a substantially constant rate or within a reasonably narrow range, regardless of the amount of fluid remaining in the container. In addition, this flow rate or flow rate range is sufficiently low that fluid will only flow out the lowermost spout opening 68. Accordingly, container 12 can be positioned in any of the three positions discussed above (upright resting on its bottom 18, or on either of left side or right side faces 22, 24) and work efficiently in any position. When the container is in a lower profile position resting on one of its left side or right side faces, 22, 24, the pressure head within the container will likely always be within the second lower pressure range. Accordingly, in either of those two orientations, the dispensing valve will operate using the larger flow passage as shown in FIG. 5.

A modification of the dispensing valve of the first embodiment will be described with respect to FIG. 6. Valve assembly 30′ is similar to valve assembly 30 described above, but discrete flow rings are not used and spring 60 is modified. Rather than discrete flow rings, a single, tapered ring 41 is used to cooperate with poppet 42. In this regard, the valve flow passage has infinite settings, from closed (when poppet 42 engages valve seat 36) to maximum. In addition, the spring rate of spring 60′ is designed to vary such that spring 60′ cooperates with actuator button 50 to move valve shaft 44 to varying degrees dependent upon the pressure head within the container. For example, regardless of the actuation force input by the user, the actuator assembly is designed to have a minimum flow opening when the container is nearly full and have a maximum flow opening when the fluid in the container is nearly depleted. More particularly, as the pressure in the container drops, the force from fluid pressure acting counter to the actuating force decreases and the spring can urge poppet 42 further in the rightward direction. This results in an increase in the cross-sectional area of the annular flow passage between the periphery of poppet 42 and tapered ring 41. Thus, as the pressure drops, the size of the flow passage increases. The valve is designed such that for every pressure level of the fluid in the container, the valve opening is adjusted to maintain a substantially constant outlet flow rate. Rather than a continuously tapered ring 41, many continuous, discrete ring steps can be formed and still achieve similar results.

It should be noted that the valve assembly is not limited to the structures described above. Any valve or flow controller can be used so long as the flow rate is within an acceptable range throughout dispensing. The valve is also not limited to use with a container or with a beverage. The valve can be used in any fields, such as medical, industrial and chemical fields, where flow control of fluids is desired.

The container and valve assembly may be constructed of any materials that are suitable for use with the dispensed fluid. Many suitable materials will be readily apparent to those of ordinary skill in the art. Likewise, the specific manufacturing techniques used to produce the various components are not important, with suitable techniques being well known to those skilled in the art. Preferably, however, the container and valve components that are in direct contact with the fluid are made of a material that is substantially non-corrosive in the fluid, such as glass, polycarbonate, acrylic, polyethyleneterephthalate (PET), polypropylene, stainless steel, polyvinyl-carbonate-(PVC), or the like. In-the case of polymers and plastics, injection molding is the preferred method of construction.

Although specific embodiments of the present invention have been described above in detail, it will be understood that this description is merely for purposes of illustration. Various modifications of, and equivalent steps corresponding to, the disclosed aspects of the preferred embodiments, in addition to those described above, may be made by those skilled in the art without departing from the spirit of the present invention defined in the following claims, the scope of which is to be accorded the broadest interpretation so as to encompass such modifications and equivalent structures.

We claim:

1. A dispensing valve for dispensing fluid from an outlet of a fluid source, said valve comprising:
a fluid passage;
a valve seat disposed in said fluid passage;
a valve member for engaging with and moving relative to said valve seat, said valve member closing said fluid passage when fully engaged with said valve seat and varying a fluid passage between said valve member and said valve seat in correspondence with movement relative to said valve seat;
an actuator for moving said valve member; and
a spring disposed between said valve member and said actuator, said spring controlling a magnitude of the movement of said valve member relative to said valve seat due to movement of said actuator, the magnitude being dependent upon pressure of the fluid source.

2. A dispensing valve according to claim 1, wherein said actuator moves said valve member among at least three positions including a closed position in which said valve member is fully engaged with said valve seat.

3. A dispensing valve according to claim 2, wherein said valve seat includes an engagement section for engaging said valve member in the closed position and a shoulder section for cooperating with said valve member to define an annular valve passage when said valve member is not in the closed position.

4. A dispensing valve according to claim 3, wherein said shoulder section comprises at least two peripheral walls of different diameters, one of said peripheral walls cooperating with said valve member to define a first annular passage of a first area and another of said peripheral walls cooperating with said valve member to define a second annular passage of a second area greater than the first area.

5. A dispensing valve according to claim 3, wherein said shoulder section is of a frusto-conical shape, said shoulder section cooperating with said valve member to define a variable annular passage, the area of which varies as said valve member moves relative to said shoulder section.

6. A dispensing valve according to claim 1, wherein the fluid source comprises a container and the outlet comprises an opening of the container.

7. A dispensing valve according to claim 1, wherein the magnitude of the movement of said valve member is greater when the pressure of the fluid source decreases.

8. A dispensing valve according to claim 1, further comprising plural valve outlets having different orientations, wherein the fluid flows through only one said valve outlets during dispensing.

9. A dispensing valve according to claim 8, wherein the fluid flows through the lowest, relative to the gravitational direction, of said plural valve outlets during dispensing.

10. A dispensing valve according to claim 1, wherein said spring has a spring constant sized to actuate said valve member without being fully compressed and without said actuator directly engaging said valve member when the pressure of the fluid source drops below a predetermined pressure.

11. A dispensing valve according to claim 10, wherein said actuator engages said valve member directly or through said spring in a fully or nearly fully compressed state when the pressure of the fluid source is at or above the predetermined pressure.

12. A dispensing valve according to claim 1, wherein said spring has a variable spring rate such that for a given magnitude of movement of said actuator, the magnitude of movement of said valve member relative to said valve seat differs at each pressure level of the fluid source.

13. A dispensing valve according to claim 1, wherein said valve member comprises a poppet having a stem engageable with said spring.

14. A dispensing valve according to claim 13, wherein said actuator comprises an engagement shaft normally separated from said stem by said spring, said engagement shaft directly engaging said stem to move said poppet when said actuator is depressed and the pressure of the fluid source is above a predetermined pressure.

15. A dispensing valve according to claim 1, wherein a fluid flow rate through the fluid passage is within a predetermined flow rate range regardless of the pressure of the fluid source.

16. A dispensing valve according to claim 15, wherein the predetermined flow rate range comprises a substantially constant flow rate.

17. A dispensing valve for dispensing fluid from an outlet of a fluid source, said valve comprising:
a fluid passage; and
means for dispensing the fluid from the outlet of the fluid source through said fluid passage within a predetermined flow rate range independently of pressure of the fluid source.

18. A dispensing valve according to claim 17, wherein the predetermined flow rate range comprises a substantially constant flow rate.

19. A dispensing valve according to claim 17, wherein the fluid source comprises a container and the outlet comprises an opening of the container.

20. A fluid dispensing system comprising:
a container having a container outlet for dispensing a fluid;
a dispensing unit having a valve and plural dispensing outlets at different dispensing positions, each of said dispensing outlets being in communication with said container outlet when said valve is open, wherein the fluid flow rate through said valve is controlled so the fluid will exit through only one of said valve outlets when dispensing.

21. A fluid dispensing system according to claim 20, wherein a dispensing outlet chamber is disposed downstream of said valve and is in common communication with said plural dispensing outlets.

22. A fluid dispensing system according to claim 20, wherein in dispensing, when fluid flows outwardly through one of said dispensing outlets, ambient air can flow into said container through at least one other dispensing outlet.

23. A fluid dispensing system according to claim 20, wherein said container is disposable in one of N positions for dispensing and the number of said dispensing outlets is N.

24. A fluid dispensing system according to claim 23, wherein said container is of a briefcase-shape and said dispensing unit is disposed near a lower end of one of two narrow sides, and in three dispensing positions, said container rests on its bottom or either of its wide sides.

25. A fluid dispensing system according to claim 20, wherein the one of said valve outlets through which the fluid exits during dispensing is the lowermost relative to the gravitational direction.
